(19) United States
(12) Patent Application Publication
(10) Pub. No.: US 2012/0000936 A1
(43) Pub. Date: Jan. 5, 2012

(54) MEDICINE DISPENSER

(75) Inventor: Ramesh Krishnamoorthy, Cary, NC (US)

(73) Assignee: INSPIRE PHARMACEUTICALS, INC., Durham, NC (US)

(21) Appl. No.: 12/826,973

(22) Filed: Jun. 30, 2010

(51) Int. Cl. B67D 7/84; B65D 37/00

(52) U.S. Cl. 222/173; 222/215

(57) ABSTRACT

A medicine dispenser is provided. The dispenser includes a container for holding a medicine. The container has a spout on a first end for dispensing the medicine and a first cap is selectively engageable with the spout. A second cap is selectively engageable about the first end of the container and has a first major surface longitudinally spaced-apart therefrom. The first major surface extends laterally at least partially outside of a periphery of the spout to form a base for supporting the container on a proximal surface.

### TECHNICAL FIELD

The presently disclosed subject matter is directed towards a medicine dispenser, and more particularly towards a medicine dispenser for dispensing liquid medicine.

### BACKGROUND

Medicine dispensers taking the form of a depressible container having a medicine within are used for applying liquid medicaments to many parts of the body, and in particular for dispensing medicine to the eye. These dispensers usually contain multiple dosages such that many applications of the medicament can be applied over a period of time. Typically, these containers are suitable for at home use by most patients. One such example of these containers may be the use of an antibiotic suspended within a viscous liquid for treating various eye infections. The antibiotic is suspended within the viscous liquid in order to maintain the antibiotic onto the surface of the eye, otherwise, a low viscosity fluid would tend to drip off of the eye and require the patient to constantly hold their head in a lay flat position.

Unfortunately, the viscous liquid does not lend itself to easy dispensing within the medicine dispenser. The viscous liquid tends to collect at the lowest portion of the bottle which is typically oppositely placed from the dispenser spout. For this reason, the dispenser must be inverted to allow the medicine to flow towards the spout before the medicine can be dispensed. This represents a time loss for doctors applying the medicine and patients using the medicine during home use.

Accordingly, there remains a need for a medicine dispenser that addresses the various disadvantages associated with previous devices.

### SUMMARY

According to one aspect of the disclosed subject matter, a medicine dispenser is provided. The dispenser includes a container for holding a medicine and has a spout on a first end thereof for dispensing the medicine. A first cap is selectively engageable with the spout. A second cap is selectively engageable about the first end of the container and has a first major surface longitudinally spaced-apart therefrom that extends laterally at least partially outside of a periphery of the spout to form a base for supporting the container on a proximal surface.

According to another aspect, the second cap and the container form a severable seam attaching the second cap to the container. The second cap and the container are detachable at the seam upon severability of the seam and removal of the second cap from the container.

According to another aspect, the second cap includes a second major surface proximally positioned about the first end of the container.

According to another aspect, the second cap includes a sidewall connecting the first and second major surfaces.

According to another aspect, the sidewall generally tapers from the first major surface towards the second major surface.

According to another aspect, the second major surface defines an aperture for selectively engaging the periphery of the container.

According to another aspect, the aperture of the second major surface engages the periphery of the container by an interference fit.

According to another aspect, the second major surface defines an aperture for selectively engaging a periphery of the spout.

According to another aspect, the aperture of the second major surface engages the periphery of the spout by an interference fit.

According to another aspect, the spout defines a length and further wherein the distance that the first major surface is longitudinally spaced-apart from the first end of the cylinder is larger than the length of the spout.

According to another aspect, the spout defines a length and further wherein the distance that the first major surface is longitudinally spaced-apart from the first end of the cylinder is generally the same as the length of the spout.

According to another aspect of the disclosed invention, a medicine dispenser is provided. The dispenser includes a container for holding a medicine and a spout connected to and in communication with a first end of the container for dispensing the medicine. A first cap is engageable with the spout. A second cap is engageable about the first end of the container and has a first major surface longitudinally spaced-apart therefrom. The first major surface is laterally extending outside of a periphery of the container to form a base for supporting the container on a proximal surface. The second cap and the container form a severable seam attaching the second cap to the container. The second cap and the container are detachable at the seam upon severability of the seam and removal of the second cap from the container.

According to another aspect of the disclosed invention, a medicine dispenser is provided. The dispenser includes a container for holding a medicine and a spout connected to and in communication with a first end of the container for dispensing the medicine. The spout defines a threaded portion for receiving a first cap having a cooperatively threaded portion. A second cap is engageable about the first end of the container. The second cap includes a first major surface longitudinally spaced-apart from the first end of the container and that laterally extends outside of a periphery of the spout to form a base for supporting the container on a proximal surface. A second major surface is proximally positioned about the first end of the container. The second major surface defines an aperture for interferencely engaging a periphery of the container. The second cap and the first end of the container form a severable seam attaching the second cap to the container. The second cap and the container are detachable upon severability of the seam and removal of the second cap from the container.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a side view of a medicine dispenser according to one embodiment of the presently disclosed subject matter;

FIG. 2 is an exploded side view of the medicine dispenser having a disposable cap removed from a container of the medicine dispenser according to one embodiment of the presently disclosed subject matter;

FIG. 3 is an exploded side view of the medicine dispenser having the disposable cap and a selectively engageable cap removed according to one embodiment of the presently disclosed subject matter;

FIG. 4 is a bottom view of a cap of the medicine dispenser according to one embodiment of the presently disclosed subject matter;

FIG. 5 is a top view of a cap of the medicine dispenser according to one embodiment of the presently disclosed subject matter;

FIG. 6 is a side view of the medicine dispenser in an inverted position resting on a proximal surface according to one embodiment of the presently disclosed subject matter;

FIG. 7A is a side view of the medicine dispenser having a severable seam connecting the disposable cap to the container of the medicine dispenser according to one embodiment of the presently disclosed subject matter;

FIG. 7B is a side view of the medicine dispenser having the disposable cap removed from the container thereby severing the severable seam according to one embodiment of the presently disclosed subject matter; and

FIG. 8 is a cross-sectional side view of the medicine dispenser having the disposable cap installed thereon according to one embodiment of the presently disclosed subject matter.

### DETAILED DESCRIPTION

The presently disclosed subject matter now will be described more fully hereinafter with reference to the accompanying drawings, in which some, but not all embodiments are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

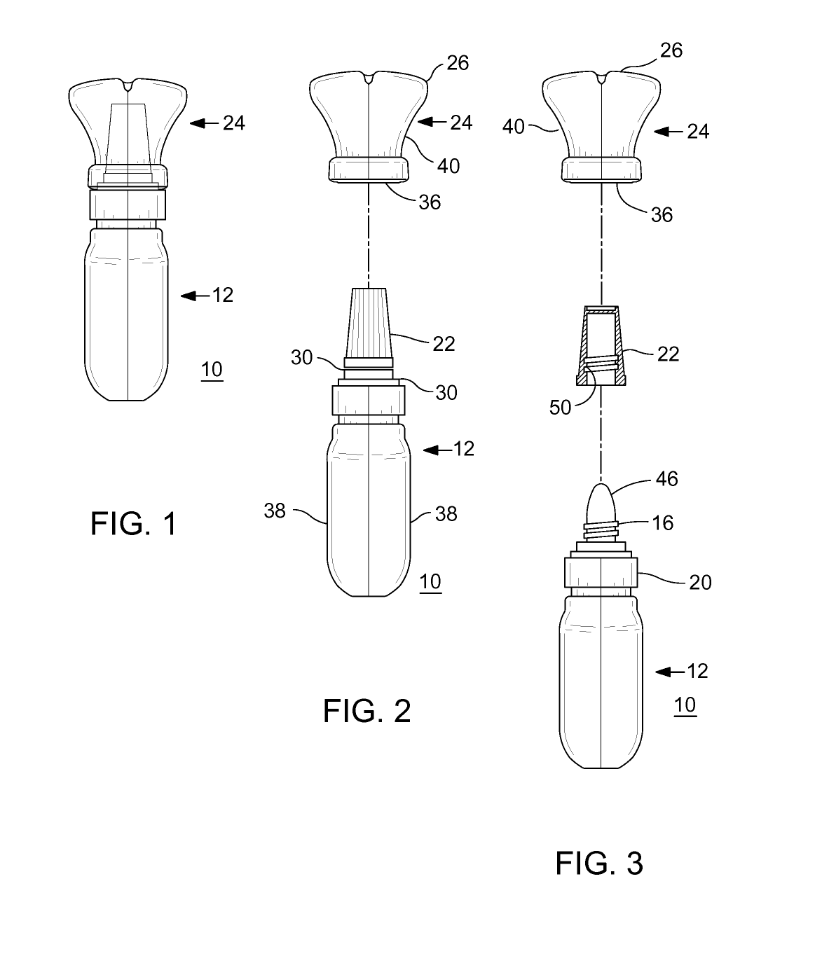

As illustrated throughout the drawings, and in particular reference to FIGS. 1 through 3, a medicine dispenser is provided and is generally designated as 10. The medicine dispenser 10 includes a container 12 for holding a medicine that may be an ocular medication and in some embodiments may be an antibiotic suspended within a viscous fluid. In some embodiments, the viscous fluid may have a viscosity of between about 1200 to 1500 centipoise. The container 12 includes a spout 16 on a first end 20 thereof for dispensing the medicine. The spout 16 may have a generally cone shape and have an opening defined on an end therein for allowing medicine to flow therethrough. A first cap 22 is selectively engageable with the spout 16, and in some embodiments, may have an internally threaded portion 50 to engage a cooperatively threaded portion 46 formed on the spout such that the first cap 22 is threadably received on the spout 16. In other embodiments, the first cap 22 may be received by the spout 16 by an interference fit, by a series of interlocking flanges, or any other suitable method.

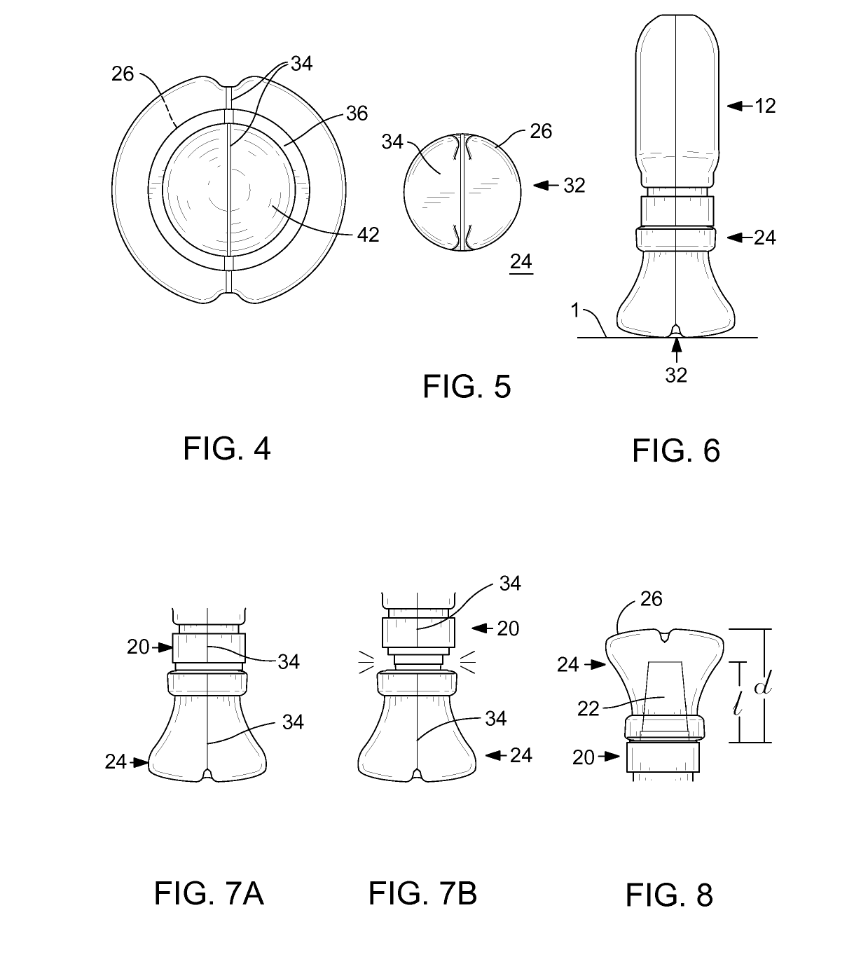

A second cap 24 is selectively engageable about the first end 20 of the container 12. The second cap 24 has a first major surface 26 longitudinally spaced-apart from the container 12. The first major surface 26 extends laterally at least partially outside of a periphery 30 of the spout 12. In this manner, the major surface 26 of the second cap 24 forms a base 32 for supporting the container 12 in an inverted position on a proximal surface 1 as shown in FIG. 6. The first major surface 26 may be generally circular in cross-section as shown in FIG. 4 and FIG. 5, but in alternate embodiments, may take on any appropriate shape to form a base surface for supporting container 12 in an upright position. Accordingly, when the dispenser 10 is positioned in an inverted orientation such that the base 32 of the second cap 24 is engaged with the proximal surface 1, the spout 16 is pointed downward and the medicine 14 will flow towards and remain in proximity to the spout 16. This allows for time efficient use of the dispenser 10 since the physician or patient does not have to wait for the medicine 14 to flow towards the spout 16 provided the physician or patient maintains the dispenser 10 in the inverted position. For medicines of higher viscosities, this time period for the medicine to flow towards the spout 16 may be significant.

The second cap 24 includes a second major surface 36 positioned proximally about the first end 20 of the container 12 when the second cap 24 is installed on the container 12. The second cap 24 includes a sidewall 40 connecting the first major surface 26 and the second major surface 36. The sidewall 40 may generally taper from the first major surface 26 towards the second major surface 36. A flanged portion 37 may also be provided that offers increased structural rigidity as compared to sidewall 40 and thus offers the physician or patient a convenient contact point for grasping the second cap 24. The second major surface 36 defines an aperture 42 for selectively engaging the outermost periphery 30 of the spout 16 or the outermost periphery 38 of the container 12. This engagement may be by an interference fit between the relatively elastic boundary defined between the second major surface 36 and the aperture 42 and the container 12 or spout 16.

As illustrated in FIG. 7A, the second cap 24 and the container 12 form a severable seam 34 attaching the second cap 24 to the container 12. This seam 34 may be formed during the manufacturing process as a molded feature of the dispenser 10. The second cap 24 and the container 12 are detachable at the seam 34 upon severability of the seam 34 and removal of the second cap 24 from the container 12 as illustrated in FIG. 7B. This may be accomplished by simply twisting the second cap 24 or pulling on the second cap 24 until the seam 34 severs. The seam 34 thereby also acts as tamper proof indicia and assures the doctor and patient that the dispenser 10 had not been previously opened. An additional seal such as a protective layer of plastic may also enclose the second cap 24. The second cap 24 may be reinstalled on the container 12 so that the dispenser 10 may be positioned in the inverted position. In this manner, the dispenser 10 can be constantly returned to the inverted position after each application of medicine. If the physician or patient no longer requires the second cap 24, such as when the medicine viscosity is such that the medicine flows sufficiently fast so that storing container 12 in an inverted position is no longer desired, the second cap 24 may be disposed of and the container 12 may be stowed in an upright position.

In order to deliver medicine to the patient, the second cap 24 is first removed by severing seam 34. The first cap 22 is then removed, and in some embodiments, this removal may be accomplished by rotating the first cap 22 to disengage threaded portions 46 and 50 of the spout 16 and first cap 22, respectively. The spout 16 is then positioned proximal the area to be treated of the patient. If necessary, the container 12 is squeezed to induce sufficient pressure to force medicine to flow from the spout 16 onto the area to be treated. The first cap 22 is then placed back into engagement with the spout 16 and the second cap 24 is then placed into engagement with the container 12 if desired. The device 10 may then be stowed in the upright or inverted position.

As illustrated in FIG. 8, the spout 16 defines a length “l” and the distance that the first major surface 26 is longitudinally spaced-apart from the first end of the cylinder is defined as “d” in FIG. 1. In some embodiments, “l” may be about the same as “d.” In other embodiments, “d” may be greater than “l.”

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A medicine dispenser comprising:
a container for holding a medicine and having a spout on a first end thereof for dispensing the medicine;
a first cap selectively engageable with the spout; and
a second cap selectively engageable about the first end of the container and having a first major surface longitudinally spaced-apart therefrom that extends laterally at least partially outside of a periphery of the spout to form a base for supporting the container on a proximal surface.

2. The dispenser according to claim 1, wherein the second cap and the container form a severable seam attaching the second cap to the container, and further wherein the second cap and the container are detachable at the seam upon severability of the seam and removal of the second cap from the container.

3. The dispenser according to claim 1, wherein the second cap includes a second major surface proximally positioned about the first end of the container when the second cap is engaged with the container.

4. The dispenser according to claim 3, wherein the second cap includes a sidewall connecting the first and second major surfaces.

5. The dispenser according to claim 4, wherein the sidewall generally tapers from the first major surface towards the second major surface.

6. The dispenser according to claim 3, wherein the second major surface defines an aperture for selectively engaging the periphery of the container.

7. The dispenser according to claim 6, wherein the aperture of the second major surface engages the periphery of the container by an interference fit.

8. The dispenser according to claim 3, wherein the second major surface defines an aperture for selectively engaging a periphery of the spout.

9. The dispenser according to claim 8, wherein the aperture of the second major surface engages the periphery of the spout by an interference fit.

10. The dispenser according to claim 1, wherein the spout defines a length and further wherein the distance that the first major surface is longitudinally spaced-apart from the first end of the cylinder is larger than the length of the spout.

11. The dispenser according to claim 1, wherein the spout defines a length and further wherein the distance that the first major surface is longitudinally spaced-apart from the first end of the cylinder is generally the same as the length of the spout.

12. A medicine dispenser comprising:
a container for holding a medicine;
a spout connected to and in communication with a first end of the container for dispensing the medicine;
a first cap engageable with the spout; and
a second cap engageable about the first end of the container and having a first major surface longitudinally spaced-apart therefrom, the first major surface laterally extending outside of a periphery of the spout to form a base for supporting the container on a proximal surface,
wherein the second cap and the container form a severable seam attaching the second cap to the container, the second cap and the container being detachable at the seam upon severability of the seam and removal of the second cap from the container.

13. The dispenser according to claim 12, wherein the second cap includes a second major surface proximally positioned about the first end of the container.

14. The dispenser according to claim 13, wherein the second cap includes a sidewall connecting the first and second major surfaces.

15. The dispenser according to claim 14, wherein the sidewall generally tapers from the first major surface towards the second major surface.

16. The dispenser according to claim 13, wherein the second major surface defines an aperture for selectively engaging the periphery of the container.

17. The dispenser according to claim 16, wherein the aperture of the second major surface engages the periphery of the container by an interference fit.

18. The dispenser according to claim 13, wherein the second major surface defines an aperture for selectively engaging a periphery of the spout.

19. The dispenser according to claim 18, wherein the aperture of the second major surface engages the periphery of the spout by an interference fit.

20. The dispenser according to claim 12, wherein the spout defines a length and further wherein the distance that the first major surface is longitudinally spaced-apart from the first end of the cylinder is larger than the length of the spout.

21. The dispenser according to claim 12, wherein the spout defines a length and further wherein the distance that the first major surface is longitudinally spaced-apart from the first end of the cylinder is generally the same as the length of the spout.

22. A medicine dispenser comprising:
a container for holding a medicine;
a spout connected to and in communication with a first end of the container for dispensing the medicine, the spout defining a threaded portion for receiving a first cap having a cooperatively threaded portion; and
a second cap engageable about the first end of the container, the second cap comprising:
a first major surface longitudinally spaced-apart from the first end of the container that laterally extends outside of a periphery of the spout to form a base for supporting the container on a proximal surface; and
a second major surface proximally positioned about the first end of the container, the second major surface defining an aperture for interferencely engaging a periphery of the container;
wherein the second cap and the first end of the container form a severable seam attaching the second cap to the container, the second cap and the container being detachable upon severability of the seam and removal of the second cap from the container.
